(19) United States
(12) Patent Application Publication
(10) Pub. No.: US 2025/0367620 A1
(43) Pub. Date: Dec. 4, 2025

(54) DEVICE FOR INJECTING A CRYOGENIC FLUID THROUGH THE BASE OF A MIXER

(71) Applicants: L'Air Liquide, Société Anonyme pour l'Etude et l'Exploitation des Procédés Georges Claude, Paris (FR); Air Liquide France Industrie, Paris (FR)

(72) Inventors: Christian REYMOND, Montmorency (FR); Michel PICHOU, Acigne (FR); Patrick LE BOT, Vincennes (FR)

(21) Appl. No.: 19/220,417

(22) Filed: May 28, 2025

(30) Foreign Application Priority Data
May 31, 2024 (FR) FRFR2405715

(51) Int. Cl. B01F 35/91; A21C 1/14; B01F 35/10; B01F 35/90

(52) U.S. Cl. CPC B01F 35/91; A21C 1/1495; B01F 35/1453; B01F 2035/98

(57) ABSTRACT

A facility for cooling products comprises a chamber for containing a product to be cooled, and a device for injecting a cryogenic fluid into the chamber, the device making it possible to inject the cryogenic fluid at one or more points located in a lower part (base) of the chamber, wherein the device comprises one or more injection nozzles connected to the lower part, wherein the cooling facility comprises a facility (120) for feeding the one or more injection nozzle with a flushing gas, wherein the one or more injection nozzles are fed with cryogenic fluid and flushing gas via a set of pipelines.

### CROSS REFERENCE TO RELATED APPLICATIONS

This application claims the benefit of priority under 35 U.S.C. § 119 (a) and (b) to French Patent Application No. FR2405715, filed May 31, 2024, the entire contents of which are incorporated herein by reference.

### BACKGROUND

The present invention relates to a device for injecting a fluid, in particular a device intended to inject, into a chamber, a cryogenic fluid under a pressure greater than the pressure prevailing in the chamber. Reference may be made in the following text to an “injection device” or “injection nozzle”.

It is known practice to cool the contents of a blender or a kneader by introducing liquid CO₂ or liquid nitrogen (LN₂) into the base of the vessel of the blender or kneader. The fluid, introduced under pressure via an injection nozzle, transforms, as soon as it expands, at the nozzle outlet, into a solid in the case of CO₂, and into liquid and cold gas in the case of nitrogen. Thus, as regards CO₂, the solid or the liquid mixes with the contents of the blender and cools it, while the cold gas likewise contributes towards cooling as it passes through the entire mass contained in the vessel.

A known solution for implementing this method comprises several injection devices that are arranged in the bottom of the vessel (lower part of the vessel) and fed with fluid by a set of pipelines.

Such cryogenic fluid injection devices are described in the document WO 2008/007000. They comprise a fluid feed head and a fluid dispensing body, through which fluid flow passages in communication with one another pass.

In these types of facility, the injection devices tend to be soiled by various contaminants, not only on their outer surfaces but also in certain parts of the fluid flow passages. Therefore, they have to be disassembled for cleaning purposes, which is mandatory in the case of food products and may be made necessary by abnormal operation or by accidental contamination.

The injection devices described in document WO 2008/007000 could be difficult to clean, justifying modifications to this prior device, modifications which the applicant proposed in document EP-3 600 682-B1. According to these modifications and improvements, the device for injecting a fluid, in particular a cryogenic fluid, comprising a fluid feed head and a fluid dispensing body mounted detachably on said feed head, was noteworthy in that said feed head comprises a fluid flow groove, feeding said body, said groove being closed in the mounted position of the body on the feed head and said groove being open in the separated position of the feed head and the body.

Thus, the open configuration of said groove results in a fluid flow passage that can be accessed easily, after dismantling the body and the head, and said dispensing head may therefore be maintained in an optimum state of cleanliness without the need for complex and ultimately unreliable cleaning operations, as was the case with prior art devices (the advantage is that once the nozzle is open, all of the surfaces to be cleaned are accessible and visible for inspection).

### SUMMARY

The present invention also relates to a facility for cooling products, in particular food products, comprising a chamber, in particular of blender or kneader type, for containing a product to be cooled, and comprising a device for injecting a cryogenic fluid into the chamber, the device making it possible to inject the fluid at one or more points located in a lower part (base) of the chamber, which device comprises one or more injection nozzles that can be connected to said lower part, wherein the cooling facility comprises a facility for feeding the or each injection nozzle with a flushing gas, for example compressed air or gaseous nitrogen, which injection nozzles are fed with cryogenic fluid and flushing gas via a set of pipelines,
characterized by the implementation of the following measures:
   the set of pipelines comprises for each of the nozzles a line for feeding the nozzle in question with cryogenic fluid, which line is equipped with a solenoid valve;
   the set of pipelines comprises, for each of the nozzles, a line for feeding the nozzle in question with said flushing gas, each flushing gas feed line being equipped in series with a calibrated orifice and a pressure sensor, the flushing line being connected, downstream of the sensor, to the cryogenic fluid feed line corresponding to it for a nozzle in question, at a point on the cryogenic fluid feed line situated between the solenoid valve and the nozzle in question.

The present invention also relates to a method for cooling products, in particular food products, implemented in a cooling facility, the facility comprising a chamber, in particular of blender or kneader type, for containing a product to be cooled, and comprising a device for injecting a cryogenic fluid into the chamber, the device making it possible to inject the fluid at one or more points located in a lower part (base) of the chamber, which device comprises one or more injection nozzles that can be connected to said lower part, wherein the cooling facility comprises a facility for feeding the or each injection nozzle with a flushing gas, for example compressed air or gaseous nitrogen, which injection nozzles are fed with cryogenic fluid and flushing gas via a set of pipelines,
characterized by the implementation of the following measures:
   the set of pipelines comprises for each of the nozzles a line for feeding the nozzle in question with cryogenic fluid, which line is equipped with a solenoid valve;
   the set of pipelines comprises, for each of the nozzles, a line for feeding the nozzle in question with said flushing gas, each flushing gas feed line being equipped in series with a calibrated orifice and a pressure sensor, the flushing line being connected, downstream of the sensor, to the cryogenic fluid feed line corresponding to it for a nozzle in question, at a point on the cryogenic fluid feed line situated between the solenoid valve and the nozzle in question;
      and characterized in that, if said pressure sensor detects a pressure below a predetermined threshold, an alert is generated, for example to request an inspection of the cooling facility or for example to report that the nozzles have not remained under overpressure and that products may have potentially entered the nozzle.

### BRIEF DESCRIPTION OF THE DRAWINGS

The structure of these prior art devices is integrated herein for reference but will nevertheless be described below by way of reminder, in detail, with the aid of the appended figures:

FIG. 1 is a schematic sectional view of a facility comprising a chamber and injection devices according to the prior art, also showing the gas feed circuit for maintaining an overpressure outside of the liquid injection phases;

FIG. 2 is a view in elevation of a device according to the prior art;

FIG. 3 is a view in longitudinal section of the device in FIG. 2;

FIG. 4 is a perspective view of a part of the device in FIG. 2, (the head) in section on the same section plane as that in FIG. 3;

FIG. 5 is a repeat of FIG. 4 according to a variant embodiment and in a slightly different orientation;

FIG. 6 is a perspective view of a variant embodiment of a device according to the prior art, of the part of the device illustrated in FIG. 4 and FIG. 5;

FIG. 7 is a perspective view of the part of the device illustrated in FIG. 6, in a section plane showing a detail of said device;

FIG. 8 is a side view showing a transparent view of a variant embodiment of a part of the device (the body) according to the prior art;

FIG. 9 is a perspective top view showing a variant assembly of a body and a head of a device according to the prior art; and

FIG. 10 is a schematic view showing a part of the device illustrated in FIG. 9, on the section plane P′ indicated in that figure.

### DETAILED DESCRIPTION OF PREFERRED EMBODIMENTS

As shown in FIGS. 1 to 3, the device 3 for injecting a fluid, in particular a cryogenic fluid, is intended to be attached to the lower part of a container containing a product to be cooled in a loose form.

The device is suitable for cooling product equally in a liquid, pasty, solid or granular form. A “pasty product” means any product having a viscosity between liquid and solid.

The cryogenic fluid used is liquid nitrogen or liquid CO₂, in particular when the product to be cooled is a food product. However, the device according to this prior art may be employed with any type of cryogenic fluid.

As an example of the use of this device, FIG. 1 shows the lower part of a container formed of a chamber 1, in particular a blending vessel, to the wall of which two devices 3 for injecting cryogenic fluid according to the prior art are attached, preferably by welding. The devices 3 are connected by a flexible hose 4 and a pipe 5 to a solenoid valve 6. The devices may be attached to the lower part of the mixing vessel.

As mentioned above in this description, FIG. 1 shows the presence of a facility 120, making it possible to feed compressed air or another flushing gas, in particular an inert gas, in particular nitrogen, to the nozzles 3:
a solenoid valve feeding gas to two lines, one line for each nozzle 3;
each line is provided with a non-return valve followed by a “pigtail” type system, the presence of the non-return valve being advantageous for ensuring that cryogen (nitrogen or CO₂) cannot pass into the circuit for compressed air, while the presence of the “pigtails” is advantageous for ensuring that the upstream component (the non-return valve) is brought into contact only with gas and not with liquid.

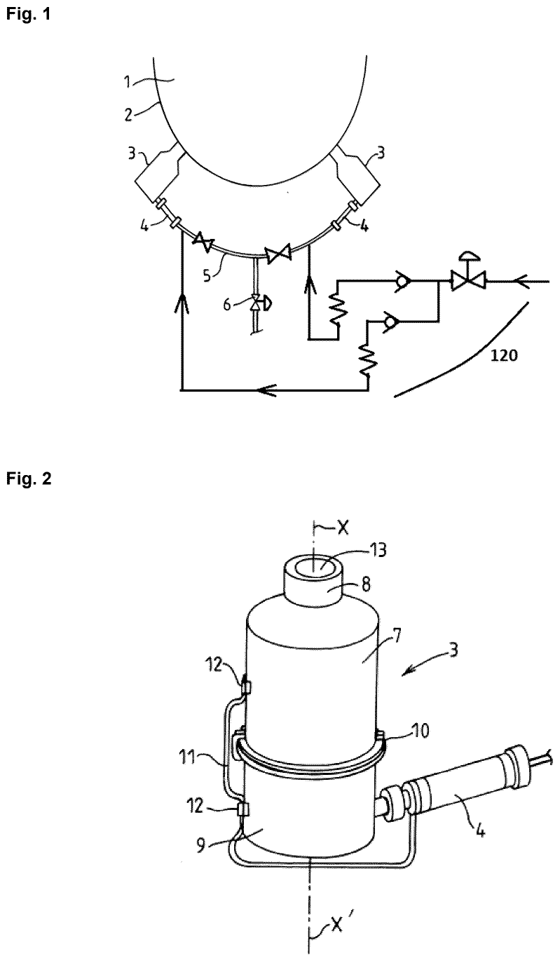

FIG. 2 shows in more detail an injection device 3 according to the prior art. It comprises, in an upper part, a fluid dispensing body 7 and, in a lower part, a feed head 9. The body 7 and the head 9 are mounted detachably on one another, notably by way of assembly clips 10. A connection of screwed type or the like could also be used.

Said device has, for example, an axisymmetric configuration about a longitudinal axis X-X′, which is in this case vertical. Said feed head 9 and said body 7 themselves extend along said longitudinal axis X-X′ in the continuation of one another. A free end 8 of said body 7 forming a neck is intended to be attached to the outer wall of the chamber 1.

Fastened to the head 9 of said device 3 is the flexible hose 4. A whip check cable 11 in this case connects the flexible hose 4, the head 9 and/or the body 7. This cable is fastened with the aid of safety hooks 12 such that only qualified persons can undo it for example for disassembly purposes.

The device is connected to the cryogenic fluid feed via the fluidic flexible duct 4. This allows rapid disassembly. Specifically, the flexible duct 4 does not have to be removed for cleaning.

Cleaning is further facilitated by the flexible duct 4 being retained on the device 3 by a rapid mechanical retention system of the quick connector type in order to also allow the removal of the flexible duct 4 if this ultimately proves necessary.

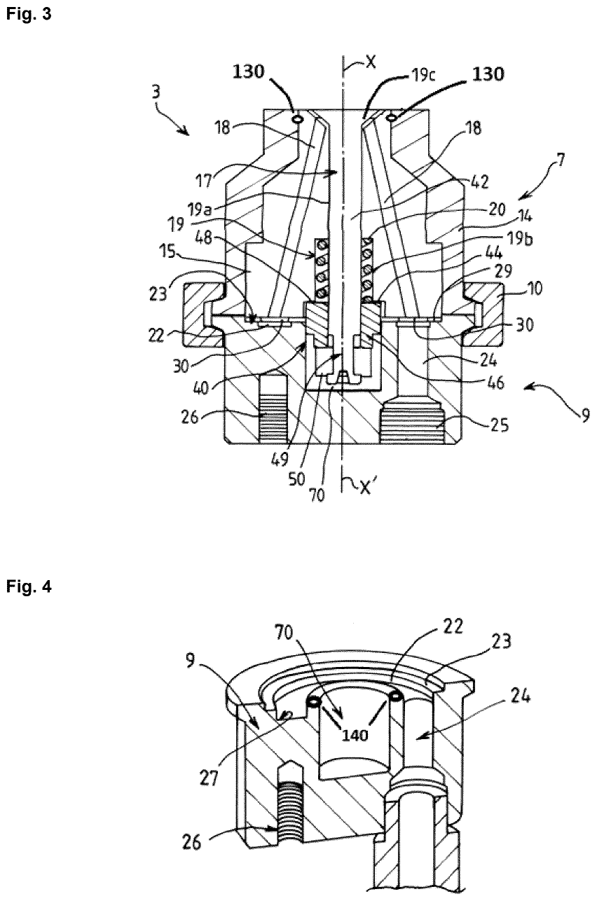

As shown in FIG. 3, said body 7 is advantageously hollow and a delivery valve 17, forced by a spring 19, is inserted into the body 7. The body 7 also comprises one or more channels 18, two of which are visible in FIG. 3. Said channels 18 are substantially parallel to said delivery valve and are intended to be fed with pressurized cryogenic fluid, an upstream end of said channels 18 being connected to said cryogenic-fluid feed head 9 and a downstream end opening out at a seat of the delivery valve 17.

The spring 19 comprises a plurality of turns. It is preloaded such that the delivery valve cannot slide without being subjected to a pressure of the cryogenic fluid at least equal to a threshold pressure.

Thus, as soon as the pressure of cryogenic fluid is less than a given threshold, the pressure necessary for sliding the delivery valve 17 will no longer be achieved and the delivery valve 17 will reposition itself tightly against its seat.

The choice of the spring and the preloading thereof depend on the cryogenic fluid that is used. Thus, for nitrogen, it should be able to be preloaded typically between 0 and 7 bar, and for CO₂ up to 25 bar.

The device comprises “n” through-channels 18, n being typically between 1 and 20, the number thereof increasing when the pressure of use of the cryogenic fluid decreases. Said channels 18 form a bundle oriented coaxially with the delivery valve 17, along the longitudinal axis X-X′, said channels being regularly distributed angularly around said axis. In particular, there are at least three of said channels. In the embodiment illustrated here, there are six. Such a configuration is particularly suitable for nitrogen applications. As stated in this prior art document, this device is not limited to such applications but may also be used for CO₂ applications. In such a case, the number of channels 18 is advantageously two, positioned at 180° with respect to one another.

The body 7 is formed, for example, of two elements, a hollow external part 14, a lower end of which bears indirectly on the head 9, and the other end of which is intended to be fastened to the wall of the chamber. Disposed inside this external part 14 is an internal part 15 of complementary shape, likewise hollow, having at its centre a through-opening accommodating the delivery valve 17. Said internal part 15 is also passed through by the channels 18.

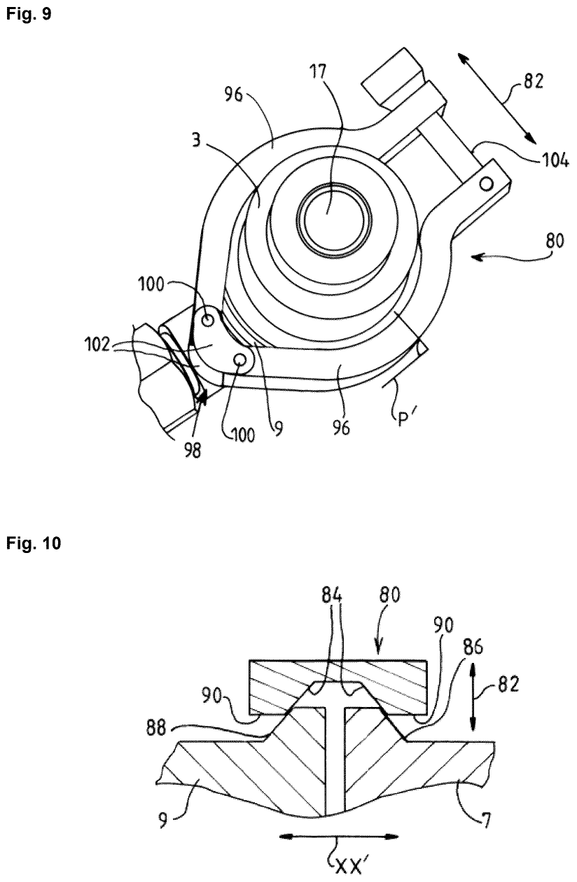

The central through-opening in the internal part 15 comprises three zones, a central zone 19a with a diameter substantially the same as that of the delivery valve such that the delivery valve can be slid in this zone, and a lower zone 19b with a larger diameter, such that it can receive, around the axis of the delivery valve, the spring 19 forcing the latter. The spring 19 is held in place by a first shoulder 20 formed between the zones 19a and 19b. At the opposite, upper end, the zone 19c has a bevelled shape, with a larger diameter at its free end, the bevelled shape being designed to define the seat of the delivery valve 17, when the delivery valve 17 is forced by the spring. Such a configuration is also visible in the embodiment in FIG. 8.

In FIG. 3, it is possible to see that there is an O-ring 130, the presence of which is very advantageous for preventing any ingress of food product, and very particularly juice or liquid, into the nozzle, when the latter is stopped, and notably between the base and the body of the nozzle, that is to say between the external part 14 and the internal part 15, which is provided with the channels 18, etc.

As is more clearly visible in FIGS. 4 to 7, said feed head 9 comprises a groove 22 for the flow of fluid feeding said body 7, more particularly all of said channels 18 of said body 7, the upstream end of which opens into said groove 22.

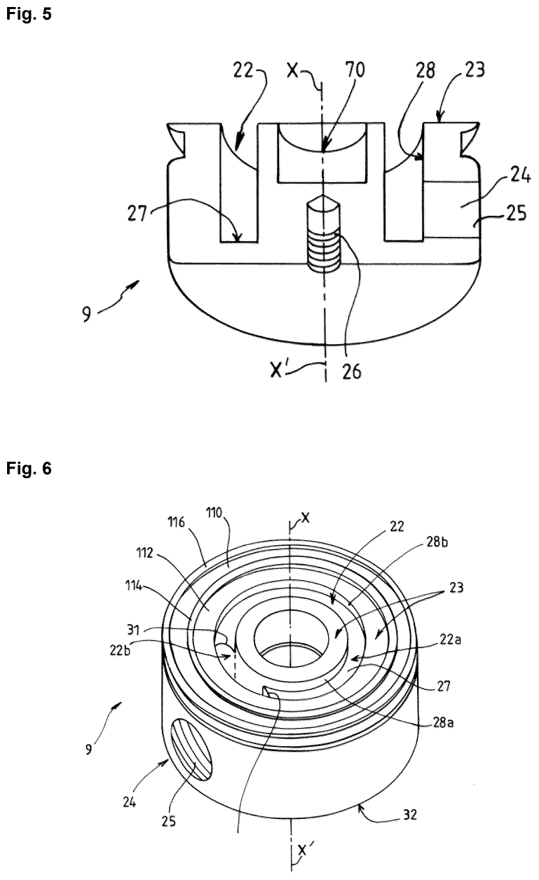

Referring again to FIG. 3, it is apparent that said groove is closed in the mounted position of the body 7 on the feed head 9. By contrast, said groove 22 is open in the separated position of the feed head 9 and the body 7, such a configuration corresponding to what is shown in FIGS. 4 and 5.

First of all, it is clear that such a groove makes it possible to establish communication with several channels 18 of the body 7 without there being only two of these channels, and even more particularly without these channels being diametrically opposite. In addition, following removal, the feed head is particularly easy to clean since an essential part thereof, namely the part formed by the groove 22, is directly accessible, notably from the open upper part of the groove.

Said feed head 9 is advantageously in one piece, that is to say formed of a single part, said groove 22 being obtained for example by machining said feed head 9. This provides a solution that is very easy to implement. Specifically, without it being necessary to dismantle a feed head 9 made up of several parts, it is possible to clean the groove 22 through the open upper part thereof.

Said feed head 9 has in this case a face 23 at which said groove 22 opens out in the separated position of the feed head 9 and the body 7, said face 23 being oriented orthogonally to the longitudinal axis of extension X-X′.

Said groove 22 is for example annular and extends angularly around the longitudinal axis X-X′. It is coaxial with the delivery valve 17.

According to the embodiment in FIGS. 3 to 5, said groove advantageously has a depth, that is to say a dimension along the longitudinal axis X-X′, that is substantially constant. In this case, it has a U-shaped cross section.

Said feed head 9 comprises a fluid flow duct 24 intended to dispense the fluid into said groove 22. Said duct 24 has, at its opposite end from the one that opens into the groove 22, an internal thread 25 that allows the abovementioned quick connector to be attached. Said feed head 9 in this case also comprises a bore 26, which is optionally tapped.

In the embodiment in FIGS. 3 and 4, said duct 24 opens out at a bottom wall 27 of the groove 22. In this embodiment, said groove has a shallow depth, namely a depth less than one quarter of an extension of said feed head in said longitudinal direction X-X′.

As shown in FIG. 5, in another embodiment, said groove 22 has a flow cross section for the fluid that is greater than the flow cross section for the fluid in the body, that is to say than the cumulative cross section of the channels 18 of the body 7. This avoids an effect of fluid expansion upstream of the outlet orifices of the channels 18.

Said groove has in this case a depth greater than three quarters of the extension of said feed head 9 in said longitudinal direction X-X′. In this embodiment, said duct 24 opens out on a side wall 28 of the groove 22.

FIG. 4 of the prior art document (and only FIG. 4 for clarity reasons) shows the advantageous presence of a seal 140, situated on the step opposite the step 23 on the other side of the slot or groove, this presence being very particularly advantageous for limiting the risks of dust getting into the groove 22.

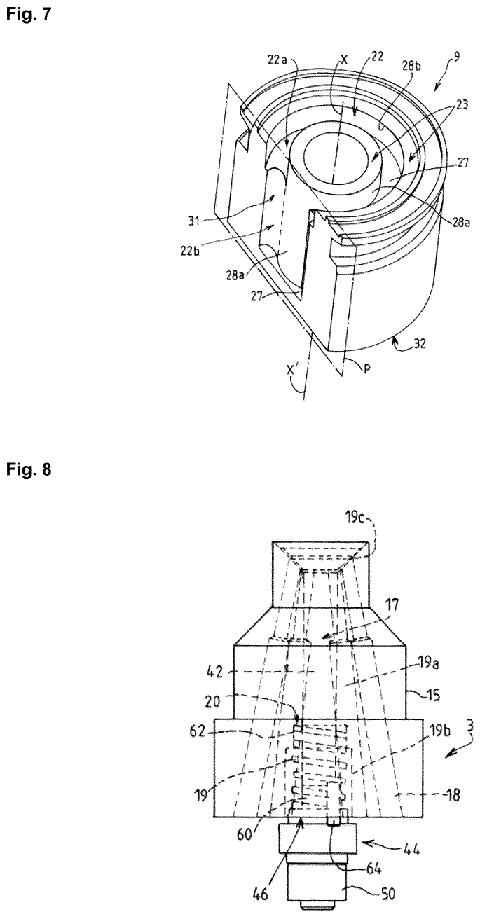

As shown in FIGS. 6 and 7, according to another prior art embodiment, a first part 22a of said groove 22 has a reduced depth and a second part has a greater depth, forming a cavity 22b. In other words, the bottom 27 of the groove is situated at two different levels. The bottom 27 of the groove is situated relatively close to the surface 23 at which said groove 22 opens out in the part 22a where the groove has a shallower depth and relatively close to a base surface 32 of said feed head 9, at the level of said cavity 22b, said base surface 32 being opposite said surface 23 along the longitudinal axis XX′ of the device. The depth of the first part 22a of the groove is, for example, two to ten times smaller than the depth of the cavity 22b, said depth being measured in each case from said surface 23 at which said groove 22 opens out down to the respective part of the bottom 27.

The cavity 22b is more clearly visible in FIG. 7, in which it is cut through the section plane P. Said cavity has a cross section substantially in the shape of an angular portion of a ring. Here, in each of its first and second parts 22a, 22b, the bottom 27 of the groove 22 is flat. The angular end edges 31 of the cavity 22b are, for example, rounded. In a variant, they could be oriented radially.

Said first part 22a of the groove and said second part 22b of the groove are complementary and form the whole of the groove 22. Each of the first part 22a of the groove 22 and the cavity 22b has an internal side wall 28a in continuity with one another, forming a cylinder, with a largest axial dimension at the level of the cavity 22b. Similarly, each of the first part 22a of the groove 22 and the cavity 22b has an external side wall 28b in continuity with one another, forming a cylinder, with a largest axial dimension at the level of the cavity 22b, this part of largest dimension being hidden in the figures. Said second part 22b of the groove 22 has an angular extent of, notably, between 30° and 90°.

According to this embodiment, said duct 24 (visible in FIG. 6) opens out on the external side wall of the groove 22, in particular at said cavity 22b, in this case substantially in the middle thereof, along the angular extent of said cavity 22b. Said duct 24 is, for example, oriented radially.

Referring again to FIG. 3, it can be seen that, preferably, said device comprises a seal 29 closing said groove 22 by bearing against the surface 23, said surface 23 forming a peripheral shoulder joined to an upper edge of the feed head 9. Said seal 29 is sandwiched between said head 9 and said body 7. Said seal 29 has orifices 30, each of the orifices 30 being situated facing one of the channels 18 of the body 7. In this way, said orifices 30 allow the fluid to pass from said groove 22 to said channels 18 of the body 7 while ensuring leaktightness between said feed head 9 and said body 7. A seal of the same type is used in the embodiments in FIGS. 5 to 7.

According to another aspect of the prior art device, said device comprises a stop 40, mounted on a stem 42 of the delivery valve, said spring 19 bearing against said stop 40.

Said stop 40 preferably comprises a first part 46, intended to be standard, and a second part 48, intended to be specific to each application. In particular, the thickness of the first part 46, that is to say the dimension of the first part 46 along the axis X-X′, is constant from one device to another, while the thickness of the second part 48 may be adapted from one application to another so as to take into account, in particular, variations in pressure inside the chamber.

In this case, said stem 42 comprises a portion 49 of reduced diameter and said stop comprises a mounting ring 50. Said stem 42 and said mounting ring 50 are mutually configured so as to allow said ring 50 to be snap-fastened on said stem 42 at said portion of reduced diameter 49 in order to axially position said first 44 and/or second parts 46 of the stop along said stem 42. Said first and second parts 44, 46 have a central bore with a diameter substantially identical to that of the stem 42, so as to be able to be fitted thereon from a proximal end of said stem 42, opposite to the end bearing the head of the delivery valve 17. Said stem 42 forms a shoulder for the mounting ring 50 at the joint between the portion of reduced diameter 49 and said distal end. Said mounting ring 50 advantageously has a symmetric configuration such that it can be mounted either way round on the stem 42 of the delivery valve. Said mounting ring 50 and the first and second parts 44, 46 of the stop have in this case an axisymmetric configuration about the axis XX′.

As shown in FIG. 8, according to a variant embodiment, said device also comprises means for centring the spring 19 so as to keep said spring radially at a distance from the delivery valve 17. In other words, by virtue of said centring means, there is a sufficiently large radial clearance to avoid contact between the stem 42 of the delivery valve and the turns of the spring 19. This prevents abrasion of these parts by rubbing against one another.

In this case, said centring means comprise a centring finger 60 for centring a first end of the spring 19. The turn(s) of the first end of the spring 19 are fitted over said centring finger 60. In other words, a diameter of said centring finger 60 and an inside diameter of the turns of the spring 19 correspond so as to allow the spring 19 to be fitted on the centring finger 60 with a very slight clearance.

Said centring finger 60 is mounted on said delivery valve 17, in particular on the stem 42 of the delivery valve. Said centring finger 60 and said stop 40, in particular the part 46 specific to each application of said stop 40, form a single part. Said centring finger has in this case an axisymmetric configuration about the axis XX′.

Said centring means in this case also comprise a guide tube 62 for guiding a second end of the spring 19, opposite to the first end. The turn(s) of the second end of the spring 19 are fitted in said tube 62. In other words, a diameter of said tube 62 and an outside diameter of the turns of the spring 19 correspond so as to allow the spring 19 to be fitted in the tube 62 with a very slight clearance. Said guide tube 62 is formed in said body, for example, in a top part of the lower zone 19b.

FIG. 8 also shows a guide pin 64 for guiding said device. This makes it possible to position said feed head 9 on said body 7.

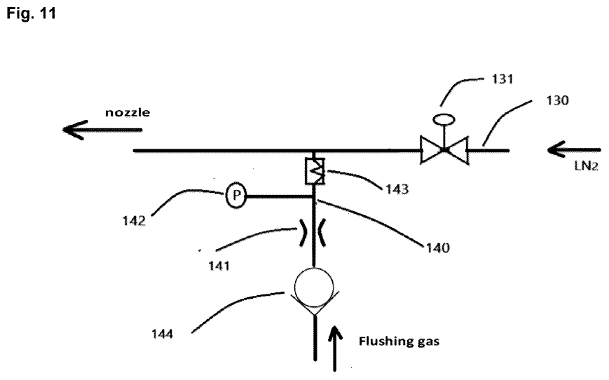

As shown in FIGS. 9 and 10, in an alternative way of attaching said feed head 9 on said body 7, said device comprises an assembly clamp 80 for assembling the body 7 and the dispensing head 9, said device being configured to convert a radial clamping movement of said clamp 80, with respect to the longitudinal axis of extension XX′ of said device, this clamping movement being illustrated here by the arrow 82 in FIG. 10, into a movement clamping the head 9 and the body 7 together along said longitudinal axis of extension XX′.

For this purpose, in this case, said clamp 80 and said body 7 and/or said head 9 have an inclined surface 84, 86, 88, which is inclined with respect to said longitudinal axis, said inclined surfaces being intended to interact with one another during the clamping of the clamp 80. This creates contact of the cone-against-cone type, by virtue of which the radial clamping of the clamp 80 makes it possible to move the head 9 towards the body 7.

The clamp 80 also comprises one or more stops 90 situated at a distal end of the inclined surface 84 of said clamp. Said stop(s) 90 of the clamp are defined by a distal annular surface of said clamp 80. Advantageously, the configuration of the inclined surfaces 84, 86, 88 makes it possible to improve the leaktightness of the device by ensuring that the head 9 is clamped against the body 7 before the clamp comes into radial abutment against the body 7 and/or the head. In other words, the stop(s) 90 of the clamp are configured to remain at a distance from one of or from said parts, in this case of cylindrical design, of the body 7 and/or of the head 9, said parts being situated in the vicinity of the inclined surfaces 86, 88 of said body 7 and/or of said head 9, respectively, after clamping.

Referring to FIG. 9, it can be seen that said clamp 80 has, for example, a clip-like configuration. It comprises two arms 96, substantially in the shape of a C that are articulated with respect to one another. Said arms 96 radially clamp said body 7 and said head 9 in the joining zone thereof.

Said arms 96 are articulated, for example, at a pivot 98. Said pivot 98 in this case comprises a hinge pin 100 for each arm 96. Said hinge pins 100 are connected by support plates 102. They are situated at one end of said arms 96. At the diametrically opposite end of said arms 96, a screw 104 of said device makes it possible to move the arms 96 towards one another in said radial clamping direction 82 of the clamp 80.

In addition or alternatively, in order to improve the leaktightness of the device, this device comprises a peripheral seal (not shown) between said feed head 9 and said body 7. Referring again to FIG. 6, it can be seen that said feed head 9 comprises in this respect, in this embodiment, a peripheral housing 110 for said peripheral seal. Said peripheral seal is situated in this case beyond the seal closing the groove 22, said seal closing the groove 22 not being shown in this figure but being intended to bear, at its external periphery, on a bearing surface 112 of the face 23 at which said groove 22 opens out.

Said peripheral housing 110 is in this case situated between an internal peripheral slot 114 and an external peripheral slot 116 of said feed head 7. Said internal peripheral slot 114 externally delimits the housing for the seal closing the groove 22. Said internal peripheral slot 114 and external peripheral slot 116 are concentric.

Said feed head 9 also has a well 70 for the movement of the delivery valve 17. Said well 70 and said groove 22 are positioned concentrically. The well 70 is in line with the opening 19b in the body 7, the stop 40 being movable in the volume formed by said well 70 and the opening 19b during the actuation of the delivery valve 17.

In operation, the valve 6 is opened, and the cryogenic fluid is sent through the pipes 5 and then the hose 4 into the device 3, through the head 9, passing through the duct 24 and the groove 22, before entering each of the channels 18 of the body 7. The pressurized fluid then exerts a pressure on the seat of the delivery valve, a space then being formed between the part 19c and the seat of the delivery valve. The solid starts to form in this space under the effects of pressure and temperature and is forced into the chamber. When it is necessary to stop the feed of cryogenic fluid, the valve 6 is closed.

The risk of liquids entering the structure of the nozzle when the nozzle is stopped were mentioned above. Specifically, it may be considered that, when the nozzle is in operation, the products treated are not liquid (for example ground meat), the products are chilled and thus viscous, and furthermore, on account of the presence of the cryogenic fluid, there is an overpressure inside the nozzle, and so the products are pushed back.

Conversely, when stopped, there is therefore a risk, depending on the products treated, of liquids entering the nozzle (when the mixer is loaded with product (product which is hot and therefore less viscous) or during cleaning (water, detergent, etc.)).

This may be the case, as mentioned, between the base and the body of the nozzle, that is to say between the external part 14 and the internal part 15; it may also be the case in the channels 18 and the cylindrical intermediate space surrounding the stem 42 of the delivery valve.

It has thus been proposed, in accordance with this prior art, to flush the nozzle when it is stopped, using compressed air (or any other flushing gas suitable for this industry), for example with the aid of the prior art facility 120 shown in FIG. 1.

It then became apparent to the applicant that it was necessary to propose improvements to the flushing device of the prior art according to document EP 3 600 682-B1.

One of the technical objectives underlying the present invention is to be able to maintain, inside the nozzle, each nozzle, an overpressure (this is the principle of a clean room) in order to be able to guarantee, preventively, that the inside of the nozzle remains and has remained clean.

This new arrangement, in addition to allowing accurate injection control, optimizes operations by cutting down on disassembly operations for nozzle cleaning, by virtue of this preventive monitoring.

This new arrangement will also make it possible to have more flexibility when integrating the nozzles on the blender (in other words, whether the hose or solenoid valve is at the top is no longer a critical issue).

It will be recalled that any contamination of the nozzle by food products may represent a health risk. Dismantling and cleaning the nozzle owing to integration on the mixer can be very detrimental.

Thus, to ensure that the inside of the nozzle remains clean, the applicant has considered it necessary to propose measures to improve the prior art device and, as will be seen in more detail below, the new facility according to the present invention seeks to achieve the following technical objectives:
a given nozzle needs to be flushed with gas permanently, as will be explained.

Even though air can be used for such flushing, it will be preferable according to the present invention to use gaseous nitrogen, and as will be seen below, the production and provision of a source of gaseous nitrogen that is always available forms part of the present proposal.

The gas source must be compatible with food safety requirements, and as such, use may be made of gaseous nitrogen from the store of liquid nitrogen present on site and used for cryogenic cooling of the mixer contents.

This flushing is preferably subject to safety conditions with the implementation of several thresholds on the oxygen content prevailing in the workshop surrounding the cooling equipment:
THRESHOLD 1: threshold considered as requiring corrective measures but cooling operations are not stopped.
THRESHOLD 2: threshold considered dangerous, requiring the feed of liquid nitrogen to the equipment to be cut off, the premises to be evacuated, and immediate corrective measures taken to restore a non-hazardous atmosphere.
THRESHOLD 3: Maintaining a slight overpressure in the nozzle results in a small leakage rate per nozzle, typically at most a few L/min.

Even in the case of THRESHOLD 2, it is preferable to maintain an overpressure in the system and continue to have a low residual flow rate (if it cannot be guaranteed that there has always been an overpressure in the nozzles, it is no longer possible to guarantee that the nozzles are clean and in this case it is in theory necessary to dismantle the nozzles in order to clean them. The quantities of gas used if this leakage rate is taken into account are normally deemed to be negligible).

By way of illustration, let THRESHOLD 3=THRESHOLD 2-1%.

This condition of flushing “permanently” is explained below.

During the cryogen injection phase, it is the cryogen that ensures an overpressure inside the nozzle in question with respect to the outside, thus ruling out the possibility of food product entering the nozzle.

A cooling treatment (for example of a batch of meat) typically lasts a few minutes, but in practise, a nozzle is injecting about 50% of the time for the cycle in question.

Take the following practical example for a better understanding of the situation: with a blender equipped with 10 nozzles, in practise, if the cycle is repeated every 10 seconds, the system can operate 5 nozzles for 5 seconds and then the other 5 nozzles for the next 5 seconds. During this 5 second pause between 2 injections through a nozzle, there is liquid trapped in the hose and this will naturally maintain an overpressure in the nozzle in question.

If the pressure on the flushing gas side is higher than the cryogenic fluid pressure, there will be a few tiny parts of gas mixed with cryogen, which has no adverse effect on the method.

Between 2 production operations, lasting several minutes or tens of minutes, the cryogenic fluid has vaporized, the pressure falls and flushing with gas may then be implemented (and it is during these times that flushing with gas makes it possible to maintain an overpressure in the nozzle).
According to the present invention, each nozzle feeding the cooling equipment is individually fed by a solenoid valve, in particular so as to be able to manage injection in a nozzle independently of the other nozzles, and thus to be able to sequence the injection phases. So as to also make it possible to control the flow rate injected per nozzle. It is also designed such that it is thus possible to inject through some of the nozzles only, depending on requirements, and thus provide an optimal supply of cryogen.
For the reasons explained below, the present invention proposes flushing conditions whereby the line bringing the flushing gas to each nozzle is equipped in series with a calibrated orifice and a pressure sensor, the flushing line connecting to the cryogen supply line, between the solenoid valve and the nozzle in question.

This arrangement makes it possible to limit the flow rate and to independently monitor the pressure in each of the nozzles.

The pressure sensor is there to detect and warn of a pressure below a predefined threshold, a sign that the nozzle is no longer being flushed or is not being flushed sufficiently.

To be specific, the calibrated orifice makes it possible to define an operating point, for a given leakage rate of the nozzle a pressure value is established in the nozzle. If this value is too low, it can be assumed that there are leaks (loose clamp, damaged seal, etc.).

This arrangement has the advantage of being able to immediately identify the faulty nozzle and target it with an intervention.

The calibrated orifice also ensures safety by limiting the flow rate and avoiding any risk.

(Since the pressure in a nozzle is typically very low—generally less than 0.5 bar to 1 bar—as the flow rate is limited by the calibrated orifice, a nozzle may be dismantled without cutting off the supply of gas for flushing).
According to a preferred embodiment of the invention, the portion of the flushing gas feed pipeline, connected to the cryogen feed line, is also equipped with a coiled section of “pigtail” type.
According to another of the preferred embodiments of the invention, the portion of the flushing gas feed pipeline, connected to the cryogen feed line, is equipped with a non-return valve.

The appended FIG. 11 is a partial schematic view of a portion of a facility in accordance with the invention, in which the following elements can be identified:
130: cryogen supply line
131: solenoid valve
140: flushing gas supply line
141: calibrated orifice
142: pressure sensor
143: “pigtail” means
144: non-return valve

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The singular forms “a”, “an” and “the” include plural referents, unless the context clearly dictates otherwise.

“About” or “around” or “approximately” in the text or in a claim means±10% of the value stated.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

What is claimed is:

1. A facility for cooling products, in particular food products, comprising:
a chamber, for containing a product to be cooled;
a device, configured to inject a cryogenic fluid into the chamber, the device making it possible to inject the cryogenic fluid at one or more points located in a lower part (base) of the chamber, wherein the device comprises one or more injection nozzles connected to the lower part; and
a feeding facility (120), configured to feed the one or more injection nozzles with a flushing gas, wherein the one or more injection nozzles are fed with the cryogenic fluid and the flushing gas via a set of pipelines, wherein
the set of pipelines comprises, for each of the injection nozzles, a cryogenic fluid feed line (130), configured to feed the nozzle in question with the cryogenic fluid, wherein the cryogenic fluid feed line is equipped with a solenoid valve (131);
the set of pipelines comprises, for each of the injection nozzles, a flushing gas feed line (140), configured to feed the nozzle in question with the flushing gas, each flushing gas feed line being equipped in series with a calibrated orifice (141) and a pressure sensor (142), the flushing gas feed line being connected,
downstream of the pressure sensor, to the cryogenic fluid feed line corresponding to the nozzle in question, at a point on the cryogenic fluid feed line situated between the solenoid valve and the nozzle in question.

2. A method for cooling products, in particular food products, implemented in a facility, wherein the facility comprises a chamber, for containing a product to be cooled, a device, configured to inject a cryogenic fluid into the chamber through one or more injection nozzles and a feeding facility (120), configured to feed the one or more injection nozzles with a flushing gas, the method comprising the steps of:
injecting the cryogenic fluid to the chamber at one or more points located in a lower part (base) of the chamber, wherein the one or more injection nozzles of the device are connected to the lower part;
feeding the one or more injection nozzles with a flushing gas, so that the one or more injection nozzles are fed with the cryogenic fluid and the flushing gas via a set of pipelines, wherein
the set of pipelines comprises, for each of the injection nozzles, a cryogenic fluid feed line (130) configured to feed the nozzle in question with the cryogenic fluid, wherein the cryogenic fluid feed line is equipped with a solenoid valve (131);
the set of pipelines comprises, for each of the nozzles, a flushing gas feed line (140), configured to feed the nozzle in question with the flushing gas, each flushing gas feed line being equipped in series with a calibrated orifice (141) and a pressure sensor (142), the flushing gas feed line being connected, downstream of the pressure sensor, to the cryogenic fluid feed line corresponding to the nozzle in question, at a point on the cryogenic fluid feed line situated between the solenoid valve and the nozzle in question; and
detecting a pressure, if the pressure is below a predetermined threshold, an alert is generated, wherein the alert either is to request an inspection of the facility or to report that the one or more nozzles have not remained under overpressure and that products have potentially entered the one or more nozzles.

3. The facility of claim 1, wherein the flushing gas is compressed air or gaseous nitrogen.

4. The facility of claim 1, wherein the chamber is a blender or kneader type chamber.

5. The facility of claim 2, wherein the flushing gas is compressed air or gaseous nitrogen.

6. The facility of claim 2, wherein the chamber is a blender or kneader type chamber.
